(19) United States
(12) Patent Application Publication
(10) Pub. No.: US 2024/0134049 A1
(43) Pub. Date: Apr. 25, 2024

(54) METHOD FOR RECOGNIZING A TRAFFIC SIGN BY MEANS OF A LIDAR SYSTEM

(71) Applicant: Robert Bosch GmbH, Stuttgart (DE)

(72) Inventor: Johannes Richter, Renningen (DE)

(21) Appl. No.: 18/546,005

(22) PCT Filed: Mar. 3, 2022
(86) PCT No.: PCT/EP2022/055377

§ 371 Date: Aug. 10, 2023

(30) Foreign Application Priority Data
Mar. 9, 2021 (DE) 10 2021 202 232.4

(51) Int. Cl. G01S 17/88

(52) U.S. Cl. CPC G01S 17/88

(57) ABSTRACT

A method for recognizing a traffic sign by means of a LiDAR system. The LiDAR system is designed to sense an intensity level of a light signal detected in the LiDAR system, the light signal including a plurality of light signal points. The method includes the following steps: a) ascertaining a degree of reflection of each light signal data point from the intensity level thereof; b) comparing the ascertained degrees of reflection with a predefined reflectivity limit value; c) if the predefined reflectivity limit value is exceeded, marking the corresponding light signal data point as belonging to a retroreflector; d) ascertaining a size of the retroreflector from the marked light signal data points. e) recognizing the retroreflector as a traffic sign as a function of the ascertained size of the retroreflector.

### FIELD

The present invention proceeds from a method for recognizing a traffic sign by means of a LiDAR system.

### BACKGROUND INFORMATION

Autonomous or semi-autonomous vehicles will increasingly find their way onto public roads in the next few years. To this end, they must be able to reliably recognize traffic signs. This usually takes place with a combination of different types of sensors.

Great Britain Patent Application No. GB 2 334 842 A describes a method for aligning the on-board preview of a LiDAR sensor with respect to the required reference direction (e.g., the direction of travel) of a vehicle.

German Patent Application No. DE 197 56 706 A1 describes a device and a method for detecting and identifying persons, vehicles and signs, wherein the signs are marked with a reflector that only reflects light of at least one particular wavelength range. In so doing, a light emitter attached to the vehicle emits a light modulated in intensity and having at least two light wavelength, and light sensors on the vehicle receive the light reflected on the reflector on the sign.

PCT Patent Application No. WO 2014/071939 A1 describes a method and a device for recognizing traffic signs, wherein information about, for example, the presence of a traffic sign, the size and position thereof is to be obtained based on data from at least one LiDAR sensor.

### SUMMARY

The present invention provides a method for recognizing a traffic sign by means of a LiDAR system.

The LiDAR system is designed to sense an intensity level of a light signal detected in the LiDAR system, wherein the light signal comprises a plurality of light signal points.

According to an example embodiment of the present invention, a degree of reflection of each light signal data point is ascertained from the intensity level thereof. The ascertained degree of reflection is compared to a predefined reflectivity limit value.

If the predefined reflexivity limit value is exceeded, the corresponding light signal data point is marked as belonging to a retroreflector. A size of the retroreflector is ascertained from the marked light signal data points. The retroreflector is recognized as a traffic sign as a function of the ascertained size.

This is advantageous since a LiDAR system is able to achieve good recognition accuracy even in bad weather. This is possible due to the active measurement principle of the LiDAR system, i.e., the emitting of light. Cameras, on the other hand, would be less able to recognize traffic signs in bad weather. Furthermore, in the presence of a LiDAR system, no additional hardware is required and implementation in the existing system is easily possible by simple reprogramming.

Further advantageous embodiments of the present invention are disclosed herein.

Expediently, according to an example embodiment of the present invention, when recognizing the retroreflector as a traffic sign, the ascertained size of the retroreflector is compared to a predefined retroreflector size limit value. If the predefined retroreflector size limit value is exceeded, the retroreflector is recognized as a traffic sign. This is advantageous since traffic signs always have a predefined size and retroreflectors smaller than traffic signs are thus eliminated and need not be taken into account further. This simplifies and accelerates traffic sign recognition and increases recognition accuracy.

Expediently, according to an example embodiment of the present invention, the type of traffic sign is classified by analyzing the background light information of the pixels of the traffic sign. In the process, the LiDAR system acts in the manner of an infrared camera. Conventional image processing and image recognition methods can thus advantageously be used. A further advantage is that no extrinsic calibration errors are to be taken into account. Such errors would be present if the LiDAR recognizes the traffic sign as a traffic sign, but the camera of the vehicle must then recognize the type of traffic sign.

Expediently, according to an example embodiment of the present invention, the traffic sign is classified by means of a neural network. This is advantageous since a neural network can be used flexibly and has very good recognition accuracy.

Expediently, according to an example embodiment of the present invention, the largest distance value is in each case selected for each pixel of the background light information. This is advantageous since even in bad weather, e.g., in rain or fog, interference by echoes of interfering influences, e.g., rain drops, can be avoided. The LiDAR system can thus see through the rain or fog, so to speak.

Expediently, according to an example embodiment of the present invention, position data of the recognized traffic sign are transmitted to an electrical control unit in order to enable data fusion with at least one further sensor. This is advantageous for increasing the accuracy of the traffic sign recognition. The sensor data fusion may be carried out directly in a sensor, e.g., a video camera, or on a central control device.

Expediently, according to an example embodiment of the present invention, the transmitted position data of the recognized traffic sign are merged with further sensor data from a further sensor in order to increase the accuracy of the traffic sign recognition. This is advantageous since the weaknesses of the individual sensors can thus be mutually compensated and the recognition accuracy is increased. An additional traffic sign recognition may, for example, take place by a camera. By merging the two recognition results, the probability of correctly recognizing the traffic sign is thus increased.

The method may, for example, be realized in a computer-implemented manner.

A further subject matter of the present invention is a device for recognizing a traffic sign, which is designed to sense an intensity level of a light signal detected in the LiDAR system, wherein the light signal comprises a plurality of light signal data points, and wherein the device comprises at least one means, in particular an electronic control unit, which is designed to perform the steps of the method according to the present invention. The aforementioned advantages can thus be achieved.

The at least one means may in particular comprise an electronic control device, which, for example, comprises a microcontroller and/or an application-specific hardware module, e.g., an ASIC, but the means may also comprise a computer.

A further subject matter of the present invention is a computer program comprising instructions that cause the device according to the present invention to perform all steps of the method according to the present invention.

A further subject matter of the present invention is a machine-readable storage medium on which the computer program is stored. The aforementioned advantages can thus be achieved.

### BRIEF DESCRIPTION OF THE DRAWINGS

Advantageous embodiments of the present invention are illustrated in the figures and explained in more detail in the description below.

FIG. 1 shows a flow chart of the method according to the present invention according to a first embodiment of the present invention.

FIG. 2 shows a flow chart of the method according to the present invention according to a second embodiment of the present invention.

FIG. 3 shows a flow chart of the method according to the present invention according to a third embodiment of the present invention.

FIG. 4 shows a schematic representation of the device according to the present invention according to one embodiment of the present invention.

### DETAILED DESCRIPTION OF EXAMPLE EMBODIMENTS

In all of the figures, identical reference signs denote identical device components or identical method steps.

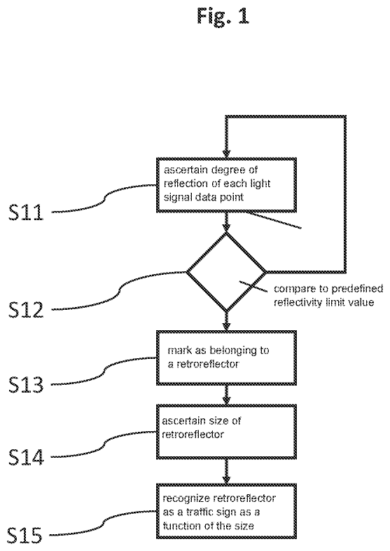

FIG. 1 shows a flow chart of the method according to the present invention according to a first embodiment. The method recognizes a traffic sign by means of a LiDAR system, wherein the LiDAR system is designed to sense an intensity level of a light signal detected in the LiDAR system. The light signal comprises several light signal points.

In a first step S11, the degree of reflection of each light signal data point is ascertained from the intensity level thereof. This may, for example, take place using the law that

$${P}_{receive} ∝ \frac{{P}_{s e n d} \cdot R}{{r}^{2}} ,$$

wherein P_{receive} is the power sensed by the LiDAR system, i.e., the intensity level of a light signal data point, P_{send} is the emitted laser power, R is the reflectivity of an object, and r is the distance between the LiDAR system and the object. This results in the variable P_{receive}·r²/P_{send} being proportional to the reflectivity R of the reflective object. The degree of reflection R is ascertained for each light signal data point.

In a second step S12, the ascertained degrees of reflection are compared to a predefined reflectivity limit value. For example, the reflectivity limit value may be compared to the value expected from a Lambert reflector with a reflectivity of 100%. Retroreflectors have the property that their reflectivity is typically above 100%, e.g., 1,000% to 100,000%.

In a third step S13, if the predefined reflexivity limit value is exceeded, the corresponding light signal data points are therefore marked as belonging to a retroreflector.

In a fourth step S14, a size of the retroreflector is ascertained from the marked light signal data points.

In a fifth step S15, the retroreflector is recognized as a traffic sign as a function of the ascertained size. For example, retroreflective objects may only be recognized as traffic signs from a size of 20 cm×20 cm. Since traffic signs typically have a defined size and shape, the shape may additionally be used to recognize the retroreflector as a traffic sign. This may improve the recognition accuracy.

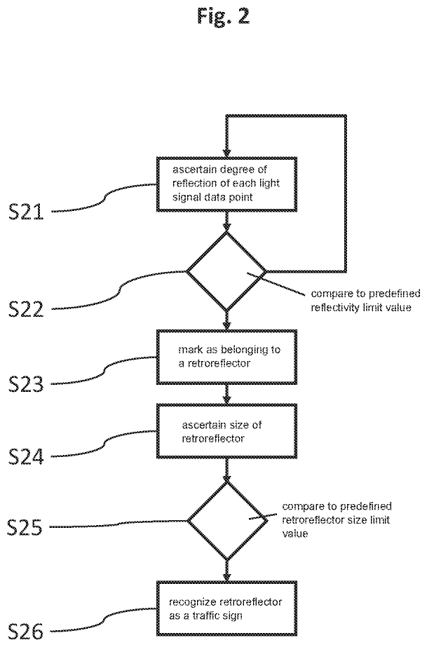

FIG. 2 shows a flow chart of the method according to the present invention according to a second embodiment. The method recognizes a traffic sign by means of a LiDAR system, wherein the LiDAR system is designed to sense an intensity level of a light signal detected in the LiDAR system. The light signal comprises several light signal points.

Steps S21 to S24 in this case correspond to steps S11 to S14 described above. Thereafter, the method is continued with steps S25 and S26 described below.

In the fifth step S25, the ascertained size of the retroreflector is compared to a predefined retroreflector size limit value. For example, the predefined retroreflector size limit value may result from a minimum size of traffic signs.

In a sixth step S26, if the predefined retroreflector size limit value is exceeded, the retroreflector is recognized as a traffic sign.

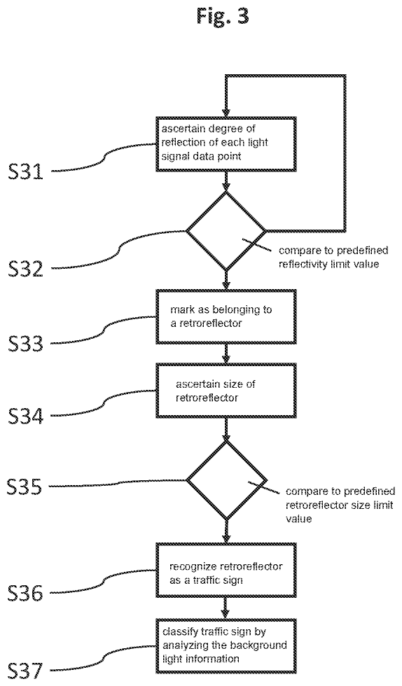

FIG. 3 shows a flow chart of the method according to the present invention according to a third embodiment. The method recognizes a traffic sign by means of a LiDAR system, wherein the LiDAR system is designed to sense an intensity level of a light signal detected in the LiDAR system. The light signal comprises several light signal points.

Steps S31 to S36 in this case correspond to steps S21 to S26 described above. Thereafter, the method is continued with step S37 described below.

In the seventh step S37, the traffic sign is classified by analyzing the background light information of the pixels of the traffic sign. Since the strong light signal from a traffic sign can cause saturation of the LiDAR system, the LiDAR system uses the background light information of each light signal data point of the traffic sign, and not the intensity information, to classify the traffic sign. The LiDAR system thus acts similarly to an infrared camera in order to classify the traffic sign. The gray level image of the background light may then be classified with suitable image processing programs, for example. Neural networks may also be used.

A LiDAR system may generate more than one distance value per scan position. This comes from the fact that there may be more than one reflection per scan position, for example as a result of rain drops or fog. Then, the LiDAR system may produce several distance values as a result of the reflection on the water droplets and on an object located behind the water droplet. In order to prevent this, the largest distance value can in each case be selected for each scan position or for each pixel of the background light information. The LiDAR system can thus “see” through the rain or fog.

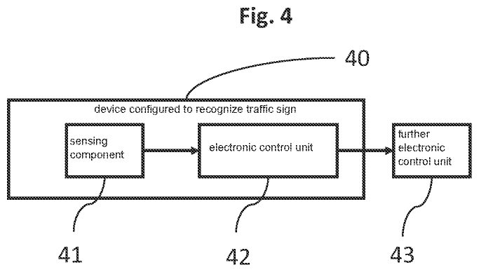

FIG. 4 shows a schematic representation of the device 40 for recognizing a traffic sign according to the present invention according to one embodiment. The device 40 comprises a LiDAR system, wherein the LiDAR system comprises a component 41 for sensing an intensity level of a light signal and an electronic control unit 42. The electronic control unit 42 is designed to perform the method according to the present invention. A LiDAR system may also comprise still further components, e.g., a component for emitting a light signal, in particular a laser beam.

The device 40 can transmit position data of a recognized traffic sign to a further electronic control unit 43, for example, from a video camera. Data fusion of two different sensor types is thus enabled. The position data of the recognized traffic sign can in this case be ascertained from the sensed light signal data points.

1-10. (canceled)

11. A method for recognizing a traffic sign using a LiDAR system configured to sense an intensity level of a light signal detected in the LiDAR system, wherein the light signal includes a plurality of light signal points, the method comprising the following steps:
a) ascertaining a degree of reflection of each light signal data point from the intensity level of light signal data point;
b) comparing the ascertained degrees of reflection to a predefined reflectivity limit value;
c) for each light signal data point, based on the predefined reflectivity limit value being exceeded, marking the light signal data point as belonging to a retroreflector;
d) ascertaining a size of the retroreflector from the marked light signal data points; and
e) recognizing the retroreflector as a traffic sign as a function of the ascertained size of the retroreflector.

12. The method according to claim 11, wherein step e) comprises the following substeps:
f) comparing the ascertained size of the retroreflector to a predefined retroreflector size limit value; and
g) based on the predefined retroreflector size limit value being exceeded, recognizing the retroreflector as a traffic sign.

13. The method according to claim 11, further comprising:
h) classifying the traffic sign by analyzing background light information of pixels of the traffic sign.

14. The method according to claim 13, wherein classifying the traffic sign takes place using a neural network.

15. The method according to claim 13, wherein a largest distance value is in each case selected for each pixel of the background light information.

16. The method according to claim 11, further comprising:
i) transmitting position data of the recognized traffic sign to an electrical control unit to enable data fusion with at least one further sensor.

17. The method according to claim 16, further comprising:
j) merging the transmitted position data of the recognized traffic sign with further sensor data from a further sensor to increase accuracy of the traffic sign recognition.

18. A device configured to recognize a traffic sign, comprising:
a LiDAR system designed to sense an intensity level of a light signal detected in the LiDAR system, wherein the light signal includes a plurality of light signal points; and
an electronic control unit configured to:
a) ascertain a degree of reflection of each light signal data point from the intensity level of light signal data point;
b) compare the ascertained degrees of reflection to a predefined reflectivity limit value;
c) for each light signal data point, based on the predefined reflectivity limit value being exceeded, mark the light signal data point as belonging to a retroreflector;
d) ascertain a size of the retroreflector from the marked light signal data points; and
e) recognize the retroreflector as a traffic sign as a function of the ascertained size of the retroreflector.

19. A non-transitory machine-readable storage medium on which is stored a computer program for recognizing a traffic sign using a LiDAR system configured to sense an intensity level of a light signal detected in the LiDAR system, wherein the light signal includes a plurality of light signal points, the computer program, when executed by an electronic control unit, causing the electronic control unit to perform the following steps:
a) ascertaining a degree of reflection of each light signal data point from the intensity level of light signal data point;
b) comparing the ascertained degrees of reflection to a predefined reflectivity limit value;
c) for each light signal data point, based on the predefined reflectivity limit value being exceeded, marking the light signal data point as belonging to a retroreflector;
d) ascertaining a size of the retroreflector from the marked light signal data points; and
e) recognizing the retroreflector as a traffic sign as a function of the ascertained size of the retroreflector.
